(19) United States
(12) Patent Application Publication
(10) Pub. No.: US 2023/0038776 A1
(43) Pub. Date: Feb. 9, 2023

(54) REMOTE CONTROL SYSTEM, REMOTE CONTROL DEVICE, AND RECORDING MEDIUM

(71) Applicant: KABUSHIKI KAISHA TOKAI RIKA DENKI SEISAKUSHO, Aichi (JP)

(72) Inventors: Yohei Niwa, Aichi (JP); Shingo Mochizuki, Aichi (JP); Haruki Yamamura, Aichi (JP); Akira Hasegawa, Aichi (JP)

(73) Assignee: KABUSHIKI KAISHA TOKAI RIKA DENKI SEISAKUSHO, Aichi (JP)

(21) Appl. No.: 17/790,502

(22) PCT Filed: Jan. 28, 2021
(86) PCT No.: PCT/JP2021/002978

§ 371 Date: Jun. 30, 2022

(30) Foreign Application Priority Data
Jan. 31, 2020 (JP) 2020-014667

(51) Int. Cl. G08C 17/02; G07C 9/00

(52) U.S. Cl. CPC G08C 17/02; G07C 9/00309

(57) ABSTRACT

A remote control system includes a first control device, a second control device, and a remote control device. The first control device performs an operation control on a first controlled device mounted on a moving body. The second control device performs an operation control on a second controlled device installed in a building. When one of the operation control on the first controlled device by the first control device and the operation control on the second controlled device by the second control device has been performed, the remote control device causes, by a remote control, an execution of an other of the operation control on the first controlled device by the first control device and the operation control on the second controlled device by the second control device.

### TECHNICAL FIELD

The present invention relates to a remote control system. The present invention also relates to a remote control device which may form a part of the remote control system, a remote control method, and a computer program executed by a processing part of the remote control device.

### RELATED ART

Patent Document 1 discloses a smart entry system as an example of a remote control system. In the system, authentication is performed through radio wave communication between a control device which controls the operation of a locking device and a key possessed by a user. If the authentication is successful, a vehicle door will be unlocked.

### RELATED ART DOCUMENTS

### Patent Document

[Patent Document 1] Japanese Patent Application Laid-Open No. 2016-21334

### SUMMARY OF INVENTION

### Problem to be Solved by Invention

An objective of the present invention is to improve convenience of a remote control system.

### Means for Solving Problem

In an aspect for achieving the above objective, a remote control system includes a first control device, a second control device, and a remote control device. The first control device performs an operation control on a first controlled device mounted on a moving body. The second control device performs an operation control on a second controlled device installed in a building. When one of the operation control on the first controlled device by the first control device and the operation control on the second controlled device by the second control device has been performed, the remote control device causes, by a remote control, an execution of an other of the operation control on the first controlled device by the first control device and the operation control on the second controlled device by the second control device.

In an aspect for achieving the above objective, a remote control device includes a reception part and a processing part. The reception part receives a first signal indicating that an operation control on a first controlled device mounted on a moving body has been performed by a first control device, and a second signal indicating that an operation control on a second controlled device installed in a building has been performed by a second control device. When performance of one of the operation control on the first controlled device by the first control device and the operation control on the second controlled device by the second control device has been detected based on reception of the first signal or the second signal, the processing part causes, by a remote control, an execution of an other of the operation control on the first controlled device by the first control device and the operation control on the second controlled device by the second control device.

In an aspect for achieving the above objective, a remote control method, which is a method of remotely controlling a first control device and a second control device by a remote control device, includes the following steps. It is determined by the remote control device whether a first signal has been received, the first signal indicating that an operation control on a first controlled device mounted on a moving body has been performed by the first control device. It is determined by the remote control device whether a second signal has been received, the second signal indicating that an operation control on a second controlled device installed in a building has been performed by the second control device. When performance of one of the operation control on the first controlled device by the first control device and the operation control on the second controlled device by the second control device has been detected based on reception of the first signal or the second signal, an other of the first control device and the second control device is remotely controlled so that an other of the operation control on the first controlled device by the first control device and the operation control on the second controlled device by the second control device is executed.

In an aspect for achieving the above objective, a computer program executed by a processing part of a remote control device, upon an execution, causes the remote control device to perform the following operations. It is determined whether a first signal has been received, the first signal indicating that an operation control on a first controlled device mounted on a moving body has been performed by a first control device. It is determined whether a second signal has been received, the second signal indicating that an operation control on a second controlled device installed in a building has been performed by a second control device. When performance of one of the operation control on the first controlled device by the first control device and the operation control on the second controlled device by the second control device has been detected based on reception of the first signal or the second signal, an other of the first control device and the second control device is remotely controlled so that an other of the operation control on the first controlled device by the first control device and the operation control on the second controlled device by the second control device is executed.

According to the configuration according to each of the above aspects, the operation control on the first controlled device by the first control device and the operation control on the second controlled device by the second control device can be linked via the remote control device. Accordingly, a remote control system with improved convenience can be realized in various forms.

### BRIEF DESCRIPTION OF DRAWINGS

FIG. 1 illustrates a functional configuration of a remote control system according to an embodiment.

FIG. 2 illustrates a configuration of the remote control system according to an embodiment.

FIG. 3 illustrates an operation of a remote control device according to an embodiment.

### DESCRIPTION OF EMBODIMENTS

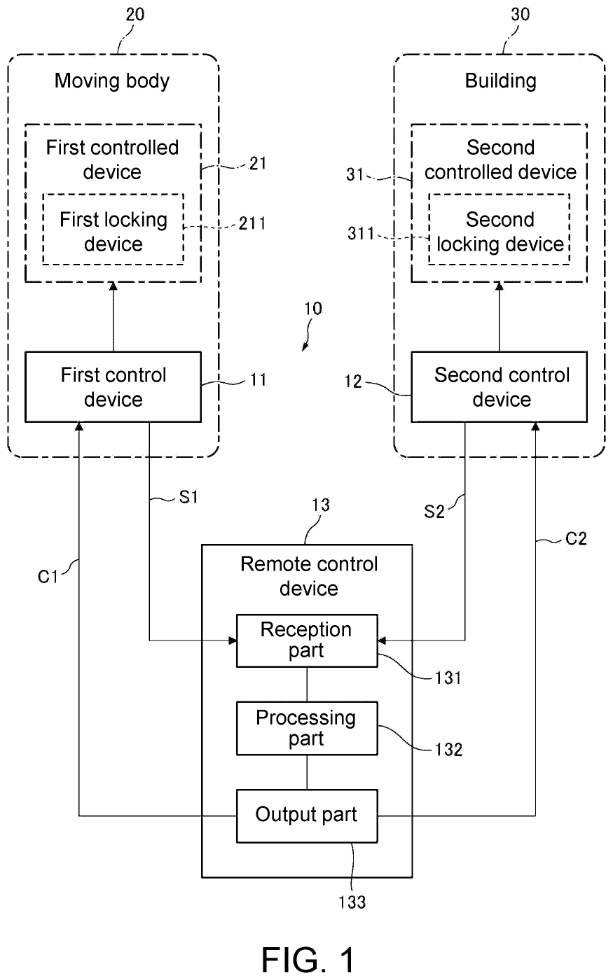

An example of an embodiment will be described in detail below with reference to the accompanying drawings. FIG. 1 illustrates a functional configuration of a remote control system 10 according to an embodiment. The remote control system 10 includes a first control device 11, a second control device 12, and a remote control device 13.

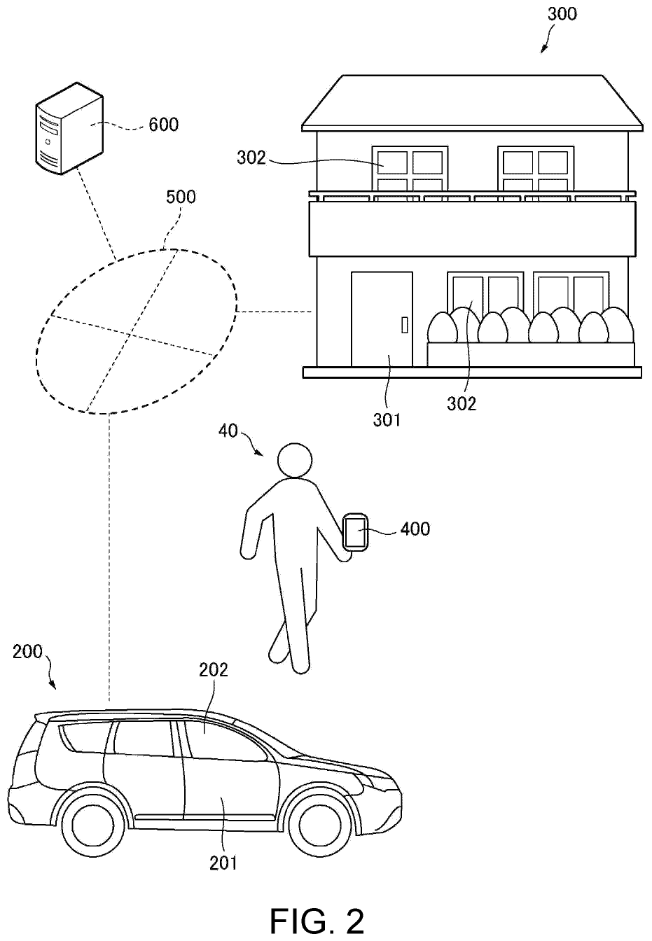

The first control device 11 is configured to control the operation of a first controlled device 21 mounted on a moving body 20. The moving body 20 is, for example, a vehicle 200 illustrated in FIG. 2. As illustrated in FIG. 1 and FIG. 2, the first controlled device 21 may include a first locking device 211 which locks and unlocks a door 201 and a window 202 of the vehicle 200. The door 201 and the window 202 of the vehicle 200 are examples of a first opening-closing body. The first controlled device 21 may include a power source, an air-conditioning apparatus, an audiovisual apparatus, a lighting apparatus, a position/posture adjusting mechanism of a seat or a steering wheel, etc. mounted on the vehicle 200.

The first control device 11 may include a processor. The processor may be realized by a general-purpose microprocessor which operates in cooperation with a general-purpose memory. Examples of the general-purpose microprocessor include a CPU, an MPU, and a GPU. Examples of the general-purpose memory include a ROM and a RAM. In this case, the ROM may store a computer program for executing operation control on the first controlled device 21. The processor specifies at least a part of the computer program stored in the ROM, loads it on the RAM, and executes the above process in cooperation with the RAM. The processor may be realized by a dedicated integrated circuit capable of executing the above computer program, such as a microcontroller, an ASIC, and an FPGA. In this case, the above computer program is pre-installed in a storage element included in the dedicated integrated circuit. The processor may also be realized by a combination of a general-purpose microprocessor and a dedicated integrated circuit.

The first control device 11 may be mounted on the moving body 20. Alternatively, as long as the operation of the first controlled device 21 can be controlled, the first control device 11 may be installed at an appropriate location outside the moving body 20.

The second control device 12 is configured to control the operation of a second controlled device 31 installed in a building 30. The building 30 is, for example, a house 300 illustrated in FIG. 2. As illustrated in FIG. 1 and FIG. 2, the second controlled device 31 may include a second locking device 311 which locks and unlocks an entrance door 301 and a window 302 of the house 300. The entrance door 301 and the window 302 of the house 300 are examples of a second opening-closing body. The second controlled device 31 may include an air-conditioning apparatus, an audiovisual apparatus, a lighting apparatus, a cooking apparatus, etc. installed in the house 300.

The second control device 12 may include a processor. The processor may be realized by a general-purpose microprocessor which operates in cooperation with a general-purpose memory. Examples of the general-purpose microprocessor include a CPU, an MPU, and a GPU. Examples of the general-purpose memory include a ROM and a RAM. In this case, the ROM may store a computer program for executing operation control on the second controlled device 31. The processor specifies at least a part of the computer program stored in the ROM, loads it on the RAM, and executes the above process in cooperation with the RAM. The processor may be realized by a dedicated integrated circuit capable of executing the above computer program, such as a microcontroller, an ASIC, and an FPGA. In this case, the above computer program is pre-installed in a storage element included in the dedicated integrated circuit. The processor may also be realized by a combination of a general-purpose microprocessor and a dedicated integrated circuit.

The second control device 12 may be installed in the building 30. Alternatively, as long as the operation of the second controlled device 31 can be controlled, the second control device 12 may be installed at an appropriate location outside the building 30.

The remote control device 13 is configured to remotely control the first control device 11 and the second control device 12. That is, in a normal state, the remote control device 13 is separated from at least one of the first control device 11 and the second control device 12. The remote control device 13 includes a reception part 131, a processing part 132, and an output part 133.

The reception part 131 is configured to receive, via wireless communication, a first signal S1 indicating that operation control on the first controlled device 21 has been performed by the first control device 11. The first signal S1 may be received from the first control device 11 as illustrated in FIG. 1 or may be received from the first controlled device 21.

The reception part 131 is configured to receive, via wireless communication, a second signal S2 indicating that operation control on the second controlled device 31 has been performed by the second control device 12. The second signal S2 may be received from the second control device 12 as illustrated in FIG. 1 or may be received from the second controlled device 31.

The processing part 132 is configured to wirelessly transmit a first control signal C1 or a second control signal C2 from the output part 133 based on reception of the first signal S1 or the second signal S2 by the reception part 131. The first control signal C1 is a signal which causes the first control device 11 to perform operation control on the first controlled device 21. The second control signal C2 is a signal which causes the second control device 12 to perform operation control on the second controlled device 31.

The remote control device 13 may be mounted on a mobile device 400 portable by a user 40, as illustrated in FIG. 2. The mobile device 400 is a device capable of executing at least one of near field communication (NFC), short-range wireless communication based on communication standards such as Bluetooth (registered trademark), and long-range wireless communication based on communication standards such as Long Term Evolution (LTE) and Bluetooth Low Energy (BLE; registered trademark). In the example of FIG. 2, the mobile device 400 is a smartphone capable of executing all of near field communication, short-range wireless communication, and long-range wireless communication.

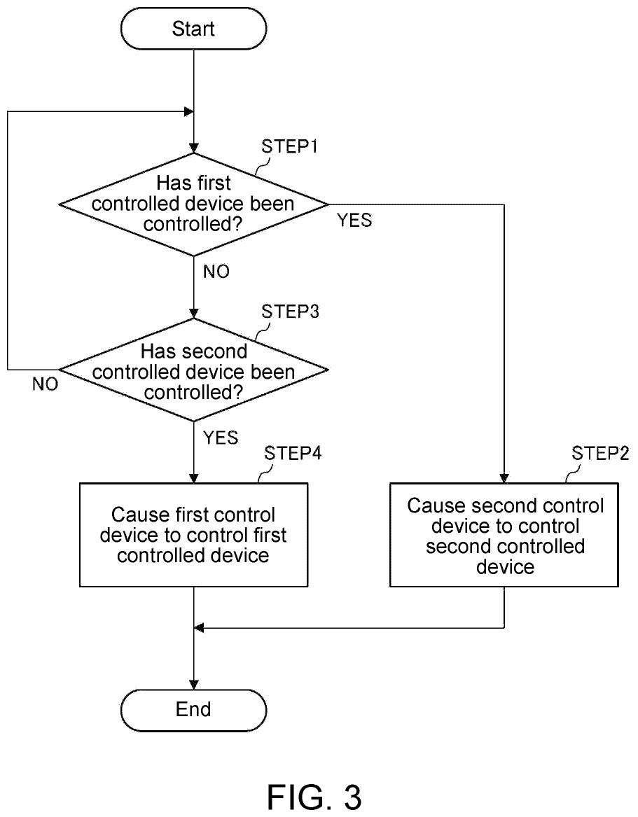

An operation example of the remote control device 13 will be specifically described with reference to FIG. 3.

Based on whether the reception part 131 has received a first signal S1, the processing part 132 determines whether a predetermined operation control related to the first controlled device 21 has been performed by the first control device 11 (STEP 1). The operation control on the first controlled device 21 by the first control device 11 does not have to be performed via the remote control device 13.

When it is determined that the predetermined operation control related to the first controlled device 21 has been performed by the first control device 11 (YES in STEP 1), the processing part 132 outputs, from the output part 133, a second control signal C2 which causes the second control device 12 to perform a predetermined operation control related to the second controlled device 31 (STEP 2), and ends the process. The second control device 12 performs the operation control on the second controlled device 31 associated with the second control signal C2.

When it is determined that the predetermined operation control related to the first controlled device 21 has not been performed by the first control device 11 (NO in STEP 1), based on whether the reception part 131 has received a second signal S2, the processing part 132 determines whether the predetermined operation control related to the second controlled device 31 has been performed by the second control device 12 (STEP 3). The operation control on the second controlled device 31 by the second control device 12 does not have to be performed via the remote control device 13.

When it is determined that the predetermined operation control related to the second controlled device 31 has been performed by the second control device 12 (YES in STEP 3), the processing part 132 outputs, from the output part 133, a first control signal C1 which causes the first control device 11 to perform the predetermined operation control related to the first controlled device 21 (STEP 4), and ends the process. The first control device 11 performs the operation control on the first controlled device 21 associated with the first control signal C1.

When it is determined that the predetermined operation control related to the second controlled device 31 has not been performed by the second control device 12 (NO in STEP 3), the process returns to STEP 1.

According to such a configuration, the operation control on the first controlled device 21 by the first control device 11 and the operation control on the second controlled device 31 by the second control device 12 can be linked via the remote control device 13. Accordingly, the remote control system 10 with improved convenience can be realized in various forms. An implementation example will be described with reference to FIG. 2.

For example, it is possible to link stop control on an engine (an example of the first controlled device 21) of the vehicle 200 and actuation control on the air-conditioning apparatus (an example of the second controlled device 31) of the house 300. Specifically, when the engine of the vehicle 200 has been stopped by the first control device 11, the remote control device 13 mounted on the mobile device 400 receives a first signal S1 indicating that stop control on the engine has been performed. The remote control device 13 outputs a second control signal C2 which causes the second control device 12 to perform actuation control on the air-conditioning apparatus of the house 300. The second control signal C2 is transmitted to the second control device 12 by, for example, long-range wireless communication. Accordingly, it is possible to realize remote control such as starting heating or cooling in the house 300 while the user 40 moves from the vehicle 200 to the house 300.

In addition to or in place of the actuation control on the air-conditioning apparatus, it is also possible to perform control of turning on an entrance light (an example of the second controlled device 31) of the house 300, control of unlocking the entrance door 301 of the house 300 by the second locking device 311, etc. The operation control on the first controlled device 21 which triggers the remote control on the second control device 12 by the remote control device 13 may also be locking of the door 201 of the vehicle 200 by the first locking device 211.

For example, it is possible to link lock control on the entrance door 301 of the house 300 performed by the second locking device 311 and actuation control on the air-conditioning apparatus (an example of the first controlled device 21) of the vehicle 200. Specifically, when the entrance door 301 of the house 300 has been locked by the second locking device 311, the remote control device 13 mounted on the mobile device 400 receives a second signal S2 indicating that the entrance door 301 has been locked. The remote control device 13 outputs a first control signal C1 which causes the first control device 11 to perform actuation control on the air-conditioning apparatus of the vehicle 200. The first control signal C1 is transmitted to the first control device 11 by, for example, long-range wireless communication. Accordingly, it is possible to realize remote control such as starting heating or cooling in the vehicle 200 while the user 40 moves from the house 300 to the vehicle 200.

In addition to or in place of the actuation control on the air-conditioning apparatus, it is also possible to perform control of turning on a light (an example of the first controlled device 21) of the vehicle 00, control of unlocking the door of the vehicle 200 by the first locking device 211, etc. The operation control on the second controlled device 31 which triggers the remote control on the first control device 11 by the remote control device 13 may also be turn-off of the lighting apparatus in the house 300.

For example, actuation control on the air-conditioning apparatus or the cooking apparatus (an example of the second controlled device 31) of the house 300 may be linked with lock control on the door 201 of the vehicle 200 performed by the first locking device 211. Specifically, when actuation control on the air-conditioning apparatus or the cooking apparatus of the house 300 by the second control device 12 has been performed through the remote control device 13 mounted on the mobile device 400, the remote control device 13 receives a second signal S2 indicating that actuation control has been performed. The remote control on the second control device 12 by the remote control device 13 may be executed, for example, through short-range wireless communication. The remote control device 13 outputs a first control signal C1 which causes the first locking device 211 to lock the door 201 of the vehicle 200. The first control signal C1 is transmitted to the first control device 11 by, for example, long-range wireless communication. The first control device 11 controls the operation of the first locking device 211 to lock the door 201 of the vehicle 200.

When the user 40 actuates the air-conditioning apparatus or the cooking apparatus in the house 300, it is highly probable that the vehicle 200 is in an unused state. By performing coordinated control to lock the door 201 of the vehicle 200 in such a situation, crime prevention can be enhanced for the vehicle 200.

The operation control on the second controlled device 31 which triggers the locking operation performed by the first locking device 211 may also be unlock control on the entrance door of the house 300 performed through the remote control device 13 mounted on the mobile device 400. In this case, the remote control on the second control device 12 by the remote control device 13 may be executed, for example, through near field communication.

For example, actuation control on the air-conditioning apparatus or the audiovisual apparatus (an example of the first controlled device 21) of the vehicle 200 may be linked with lock control on the entrance door 301 or the window 302 of the house 300 performed by the second locking device 311. Specifically, when actuation control on the air-conditioning apparatus or the cooking apparatus of the vehicle 200 by the first control device 11 has been performed through the remote control device 13 mounted on the mobile device 400, the remote control device 13 receives a first signal S1 indicating that actuation control has been performed. The remote control on the first control device 11 by the remote control device 13 may be executed, for example, through short-range wireless communication. The remote control device 13 outputs a second control signal C2 which causes the second locking device 311 to lock the entrance door 301 or the window 302 of the house 300. The second control signal C2 is transmitted to the second control device 12 by, for example, long-range wireless communication. The second control device 12 controls the operation of the second locking device 311 to lock the entrance door 301 or the window 302 of the house 300.

When the user 40 actuates the air-conditioning apparatus or the audiovisual apparatus in the vehicle 200, it is highly probable that the user 40 is away from the house 300. By performing coordinated control to lock the entrance door 301 or the window 302 of the house 300 in such a situation, crime prevention can be enhanced for the house 300.

The operation control on the first controlled device 21 which triggers the locking operation performed by the second locking device 311 may also be unlock control on the door 201 of the vehicle 200 performed through the remote control device 13 mounted on the mobile device 400. In this case, the remote control on the first control device 11 by the remote control device 13 may be executed, for example, through near field communication.

The processing part 132 of the remote control device 13 having the above functions may be realized by a general-purpose microprocessor which operates in cooperation with a general-purpose memory. Examples of the general-purpose microprocessor include a CPU, an MPU, and a GPU. Examples of the general-purpose memory include a ROM and a RAM. In this case, the ROM may store a computer program for executing the above process. The ROM is an example of a storage medium storing the computer program. The processor specifies at least a part of the computer program stored in the ROM, loads it on the RAM, and executes the above process in cooperation with the RAM. The above computer program may be pre-installed in a general-purpose memory or may be downloaded from an external server device 600 via a wireless communication network 500 illustrated in FIG. 2 and installed in the general-purpose memory. In this case, the external server is an example of a storage medium storing the computer program.

The processing part 132 may be realized by a dedicated integrated circuit capable of executing the above computer program, such as a microcontroller, an ASIC, and an FPGA. In this case, the above computer program is pre-installed in a storage element included in the dedicated integrated circuit. The storage element is an example of a storage medium storing the computer program. Each processor may also be realized by a combination of a general-purpose microprocessor and a dedicated integrated circuit.

The above embodiment is merely an example for facilitating understanding of the present invention. The configuration according to the above embodiment may be appropriately modified or improved without departing from the spirit of the present invention.

In the above embodiment, the remote control device 13 which remotely controls one of the first control device 11 and the second control device 12, and the remote control device 13 which is triggered by such remote control to remotely control the other of the first control device 11 and the second control device 12 are the same device mounted on the mobile device 400 portable by the user 40. However, it is also possible to provide, as separate devices, a remote control device which remotely controls one of the first control device 11 and the second control device 12 and a remote control device which is triggered by such remote control to remotely control the other of the first control device 11 and the second control device 12.

For example, at least one of locking/unlocking of the door of the vehicle 200 performed by the first locking device 211 and locking/unlocking of the entrance door of the house 300 performed by the second locking device 311 may be performed using a portable device which only has a near field communication function. In this case, triggered by the remote control on one of the first control device 11 and the second control device 12 performed by using the portable device, a mobile device having at least one of a short-range wireless communication function and a long-range wireless communication function may perform remote control on the other of the first control device 11 and the second control device 12.

The remote control device 13 does not need to be carried by the user 40. For example, the remote control device 13 may be mounted on the external server device 600 illustrated in FIG. 2. The external server device 600 may be configured to be capable of executing wireless communication with at least one of the first control device 11 and the second control device 12 through the wireless communication network 500. For example, the remote control on one of the first control device 11 and the second control device 12 may be executed by the remote control device 13 mounted on the mobile device 400 portable by the user 40. In this case, triggered by the remote control on one of the first control device 11 and the second control device 12 performed by the remote control device 13 mounted on the mobile device 400, the remote control device 13 mounted on the external server device 600 may perform remote control on the other of the first control device 11 and the second control device 12.

The moving body on which the first controlled device 21 is mounted is not limited to the vehicle 200. Examples of the moving body include a railroad, an aircraft, a ship, etc. The moving body does not have to require a driver.

The building in which the second controlled device 31 is installed is not limited to the house 300. Examples of the building include a commercial facility, a school building, a company building, a factory, a research facility, etc.

### REFERENCE SIGNS LIST

10: Remote control system, 11: First control device, 12: Second control device, 13: Remote control device, 131: Reception part, 132: Processing part, 20: Moving body, 200: Vehicle, 201: Door, 202: Window, 21: First controlled device, 211: First locking device, 30: Building, 300: House, 301: Entrance door, 302: Window, 31: Second controlled device, 311: Second locking device, 40: User, 400: Mobile device, S1: First signal, S2: Second signal

1. A remote control system comprising:
a first control device which performs an operation control on a first controlled device mounted on a moving body;
a second control device which performs an operation control on a second controlled device installed in a building; and
a remote control device, wherein when one of the operation control on the first controlled device by the first control device and the operation control on the second controlled device by the second control device has been performed, the remote control device causes, by a remote control, an execution of an other of the operation control on the first controlled device by the first control device and the operation control on the second controlled device by the second control device.

2. The remote control system according to claim 1, wherein the first controlled device comprises a first locking device which locks and unlocks a first opening-closing body provided on the moving body, and
when the operation control on the second controlled device is performed by the second control device, the remote control device remotely controls the first control device to cause the first locking device to lock or unlock the first opening-closing body.

3. The remote control system according to claim 1, wherein
the second controlled device comprises a second locking device which locks and unlocks a second opening-closing body provided in the building, and
when the operation control on the first controlled device is performed by the first control device, the remote control device remotely controls the second control device to cause the second locking device to lock or unlock the second opening-closing body.

4. The remote control system according to claim 1, wherein the remote control device is mounted on a mobile device portable by a user.

5. A remote control device comprising:
a reception part which receives a first signal indicating that an operation control on a first controlled device mounted on a moving body has been performed by a first control device, and a second signal indicating that an operation control on a second controlled device installed in a building has been performed by a second control device; and
a processing part, wherein when performance of one of the operation control on the first controlled device by the first control device and the operation control on the second controlled device by the second control device has been detected based on reception of the first signal or the second signal, the processing part causes, by a remote control, an execution of an other of the operation control on the first controlled device by the first control device and the operation control on the second controlled device by the second control device.

6. (canceled)

7. (canceled)

8. (canceled)

9. A non-transitory computer readable recording medium, storing a computer program executed by a processing part of a remote control device, wherein upon an execution, the computer program causes the remote control device to:
determine whether a first signal has been received, wherein the first signal indicates that an operation control on a first controlled device mounted on a moving body has been performed by a first control device,
determine whether a second signal has been received, wherein the second signal indicates that an operation control on a second controlled device installed in a building has been performed by a second control device, and
when performance of one of the operation control on the first controlled device by the first control device and the operation control on the second controlled device by the second control device has been detected based on reception of the first signal or the second signal, remotely control an other of the first control device and the second control device so that an other of the operation control on the first controlled device by the first control device and the operation control on the second controlled device by the second control device is executed.

10. The remote control system according to claim 2, wherein
the second controlled device comprises a second locking device which locks and unlocks a second opening-closing body provided in the building, and
when the operation control on the first controlled device is performed by the first control device, the remote control device remotely controls the second control device to cause the second locking device to lock or unlock the second opening-closing body.
